(19) United States
(12) Patent Application Publication
(10) Pub. No.: US 2011/0020769 A1
(43) Pub. Date: Jan. 27, 2011

(54) ORTHODONTIC IMPLANT SCREW ASSEMBLY

(76) Inventor: Woosung YUN, Seoul (KR)

Correspondence Address: LADAS & PARRY LLP, 224 SOUTH MICHIGAN AVENUE, SUITE 1600, CHICAGO, IL, 60604, US

(21) Appl. No.: 12/838,623

(22) Filed: Jul. 19, 2010

(30) Foreign Application Priority Data
Jul. 22, 2009 (KR) 10-2009-0067039

(51) Int. Cl. A61C 8/00

(52) U.S. Cl. 433/174

(57) ABSTRACT

An orthodontic implant screw assembly, and more particularly, an orthodontic implant screw assembly that is inserted and fixed in periodontal tissues or jawbone of a human body and is pulled out by using a wire or the like so as to perform orthodontic treatment of a mouth structure. An orthodontic implant screw assembly having an improved structure in which an upper protrusion of the orthodontic implant screw assembly is detachable and replaceable according to needs so as to reduce patient's inconvenience according to operations of orthodontic treatment and so as to easily use a head having a different shape according to the operations of orthodontic treatment. When the orthodontic implant screw assembly is not temporarily used according to operations of orthodontic treatment of a mouth structure, a head having a small height and a small size can be replaced with other one so that patient's inconvenience can be reduced. Furthermore, when the orthodontic implant screw assembly including a head having a different shape according to the operations of orthodontic treatment of the mouth structure needs to be used, the orthodontic implant screw assembly is not replaced with other one but only an upper head of the orthodontic implant screw assembly is replaceable so that efficiency of orthodontic treatment can be improved and patient's inconvenience can be reduced.

### CROSS-REFERENCE TO RELATED PATENT APPLICATION

This application claims the benefit of Korean Patent Application No. 10-2009-0067039, filed on Jul. 22, 2009, in the Korean Intellectual Property Office, the disclosure of which is incorporated herein in its entirety by reference.

### BACKGROUND OF THE INVENTION

1. Field of the Invention

The present invention relates to an orthodontic implant screw assembly, and more particularly, to an orthodontic implant screw assembly that is inserted and fixed in periodontal tissues or jawbone of a human body and is pulled out by using a wire or the like so as to perform orthodontic treatment of a mouth structure.

2. Description of the Related Art

Generally, orthodontic treatment of teeth or a mouth structure is performed in such a way that orthodontic implant screws are inserted and fixed in periodontal tissues or jawbone of a human body and are pulled out by hanging wires in the orthodontic implant screws.

Such orthodontic implant screws are not always used in the entire orthodontic treatment but are used while changing the size and direction of force to be applied to operations of orthodontic treatment. Also, as occasion demands, the inserted orthodontic implant screws are not temporarily used but are used to perform orthodontic treatment of other portions, and if necessary, the wires are hung to proceed orthodontic treatment.

However, general orthodontic implant screws protrude from an outside of periodontal tissues so as to fix wires and thus are used in orthodontic treatment and cause inconvenience to a patient who use orthodontic implant screws or does not use them directly. Since predetermined orthodontic implant screws are not temporarily used in orthodontic treatment, the predetermined orthodontic screws are removed from the periodontal tissues and are re-inserted in the periodontal tissues or jawbone of the human body when they are used. In this case, patient's periodontal tissues or the like may be injured.

Thus, an orthodontic implant screw assembly having a structure in which, when orthodontic implant screws are not temporarily used in orthodontic treatment, they do not protrude from an outside of the periodontal tissues to reduce patient's inconvenience, is required.

Also, when orthodontic treatment of the mouth structure of the patient is stepwise performed and the structure or shape of an upper head of each of orthodontic implant screws needs to be changed, the orthodontic implant screws should be removed from the periodontal tissues, and orthodontic implant screws having other structure should be inserted in the periodontal tissues or jawbone of the human body. However, such a replacement work may increase patient's inconvenience and may injure the periodontal tissues or jawbone. Thus, an orthodontic implant screw assembly having a structure in which portions of orthodontic implant screws inserted in the periodontal tissues are maintained and only a head in which wires are fixed, is replaceable, is necessary.

### SUMMARY OF THE INVENTION

The present invention provides an orthodontic implant screw assembly having an improved structure in which an upper protrusion of the orthodontic implant screw assembly is detachable and replaceable according to needs so as to reduce patient's inconvenience according to operations of orthodontic treatment and so as to easily use a head having a different shape according to the operations of orthodontic treatment.

According to an aspect of the present invention, there is provided an orthodontic implant screw assembly including: a screw body including a male screw portion inserted and fixed in periodontal tissues or jawbone and a combination hole extending from an upper side of the male screw portion in a lengthwise direction; a head including an insertion inserted in the combination hole of the screw body and a protrusion formed at an upper side of the insertion and protruding from an upper side of the screw body; and combination portions combining the head with the screw body when the insertion of the head is inserted in the combination hole of the screw body, wherein sandblasted uneven surfaces are formed on surfaces in which the screw body and the protrusion of the head face each other, and adhesion grooves are formed between the uneven surface of the screw body and the uneven surface of the head in such a way that the screw body and the head adhere each other by using a dental adhesive.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view of an orthodontic implant screw assembly according to an embodiment of the present invention;

FIG. 2 is a cross-sectional view of the orthodontic implant screw assembly illustrated in FIG. 1;

FIG. 3 is a front view of an orthodontic implant screw assembly according to another embodiment of the present invention;

FIG. 4 is a cross-sectional view of the orthodontic implant screw assembly illustrated in FIG. 3, taken along a line IV-IV; and

FIG. 5 is a front view of an orthodontic implant screw assembly according to another embodiment of the present invention.

### DETAILED DESCRIPTION OF THE INVENTION

The present invention will now be described more fully with reference to the accompanying drawings, in which exemplary embodiments of the invention are shown.

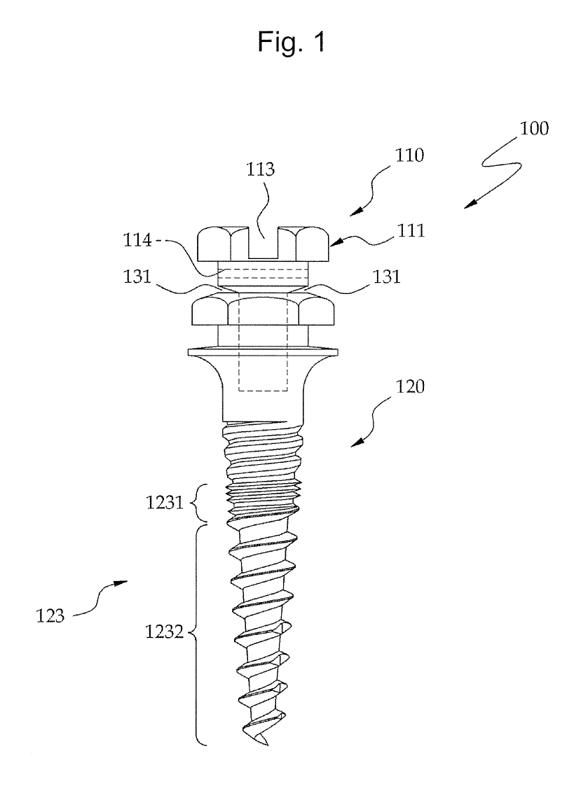

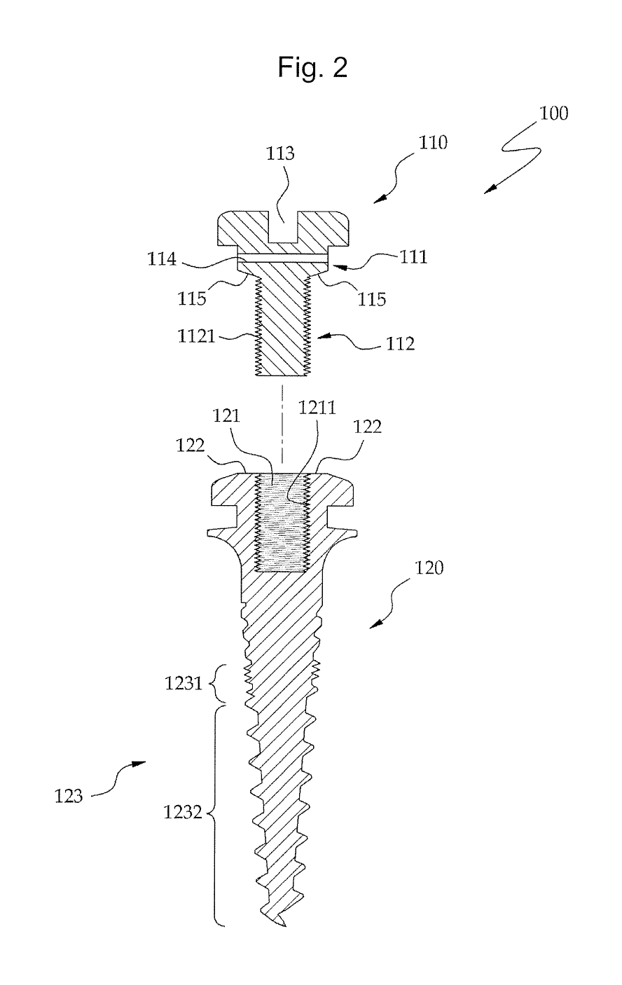

FIG. 1 is a front view of an orthodontic implant screw assembly 100 according to an embodiment of the present invention, and FIG. 2 is a cross-sectional view of the orthodontic implant screw assembly 100 illustrated in FIG. 1.

Referring to FIGS. 1 and 2, the orthodontic implant screw assembly 100 according to the present embodiment includes a screw body 120, a head 110, and combination portions 1121 and 1211.

The screw body 120 is inserted and fixed in the periodontal tissues or jawbone of a patient to fix the orthodontic implant screw assembly 100. The screw body 120 includes a male screw portion 123 and a combination hole 121. The male screw portion 123 includes male screws 1231 and 1232 formed outside the male screw portion 123, as illustrated in FIG. 1. The male screws 1231 and 1232 are inserted and fixed in the periodontal tissues or jawbone of the patient. The combination hole 121 extends from an upper side of the screw body 120 in a lengthwise direction. In other words, the screw body 120 includes the male screw portion 123 formed outside the screw body 120, and the combination hole 121 that is formed in the screw body 120 and extends so that the upper side of the screw body 120 may be opened. The orthodontic implant screw assembly 100 includes a female screw 1211 formed in the combination hole 121. As illustrated in FIG. 1, when an upper side of the male screw portion 123 of the screw body 120 is formed as a double thread screw 1231 and a lower side of the male screw portion 123 of the screw body 120 is formed as a single thread screw 1232, the screw body 120 may be easily inserted in the periodontal tissues and a contact area between the screw body 120 and the human tissues increases due to the double thread screw 1231 so that a fixing force may be improved. Meanwhile, a pitch of the single thread screw 1232 may be twice of a pitch of the double thread screw 1231 so that, when the screw body 120 is inserted in the periodontal tissues, the single thread screw 1232 and the double thread screw 1231 may be inserted in the periodontal tissues harmoniously.

The head 110 includes an insertion 112 and a protrusion 111 and is inserted and combined in the combination hole 121 of the screw body 120. The insertion 112 extends in a lengthwise direction and includes the male screw 1121 formed outside the insertion 112 so that the male screw 1121 may be inserted in the combination hole 121 of the screw body 120 and may be screw-combined therewith. The protrusion 111 is formed at an upper side of the insertion 112. When the insertion 112 is inserted in the combination hole 121 of the screw body 120, the protrusion 111 protrudes from an upper side of the screw body 120. A hole 114 for fixing wires or a catch groove in which wires are caught is formed in the protrusion 111 so that the hole 114 or the catch groove may be combined with orthodontic implant wires or the like and orthodontic treatment may be performed.

The combination portions 1121 and 1211 combine the head 110 with the screw body 120 when the insertion 112 of the head 110 is inserted in the combination hole 121 of the screw body 120. In FIG. 1, the female screw 1211 formed in the combination hole 121 and the male screw 1121 formed outside the insertion 110 correspond to the combination portions.

Meanwhile, surfaces in which the screw body 120 and the protrusion 111 of the head 110 face each other, are sandblasted and become uneven surfaces 122 and 115. The uneven surfaces 122 and 115 are processed by sandblasting, etching, anodization or the like so as to improve surface roughness and so as to increase a surface area. Also, adhesion grooves 131 are formed in surfaces in which the uneven surfaces 122 and 115 face each other, as illustrated in FIG. 1. When the head 110 is combined with the screw body 120 and fixed therein, a dental adhesive is filled in the adhesion grooves 131 formed due to the uneven surfaces 122 and 115 so that a combination force of the combination portions 1121 and 1211 may be improved.

Hereinafter, a way to use the orthodontic implant screw assembly 100 having the above structure of FIG. 1 will be described.

First, a guide hole is formed in patient's periodontal tissues by using a drill, and the screw body 120 is inserted in the periodontal tissues by using a driver. In this manner, the screw body 120 is fixed in the periodontal tissues, the insertion 112 of the head 110 is inserted in the combination hole 121 and is rotated by using the driver. When a driver slot 113 is formed in an upper side of the head 110, as illustrated in FIG. 1, the head 110 is rotated by using the driver so that the head 110 may be easily combined with the screw body 120.

When the head 110 is combined with the screw body 120, the protrusion 111 of the head 110 is exposed to the upper side of the screw body 120. Thus, orthodontic treatment of the mouth structure of the patient is performed by installing orthodontic implant wires or other device at the protrusion 111.

When the head 110 is combined with the screw body 120, the dental adhesive is filled in the adhesion grooves 131 so that the head 110 and the screw body 120 may be securely combined with each other. Generally, orthodontic treatment is performed for a long time, such as for several months. Thus, screw-combination of the screw body 120 and the head 110 may be loosened or released during a patient's life. However, as described above, the screw body 120 and the head 110 are combined with each other by using the uneven surfaces 115 and 122 and the adhesion grooves 131 so that screw-combination of the screw body 120 and the head 110 may be fundamentally prevented from being released.

There may be a period in which predetermined orthodontic implant screw assembly is not temporarily used when orthodontic treatment of the mouth structure of the patient is performed for a long time. In this case, although orthodontic treatment is not performed by hanging wires in a head, a protrusion of the head protrudes from an outside of the periodontal tissues so that the patient's life may be inconvenient. In this case, the head 110 is released from the screw body 120 and the head 110 having a very small size of the protrusion 111 is temporarily combined with the screw body 120 so that patient's inconvenience may be reduced. In this case, as described above, when the dental adhesive is filled in the adhesion grooves 131 and the head 110 and the screw body 120 are combined with each other, portions of the dental adhesive are ground by using a grinder so that the head 110 may be easily detached from the screw body 120.

In this manner, the head 110 and the screw body 120 are constituted to be combined with each other or to be detached from each other according to needs so that the head 110 having an appropriate structure and shape according to treatment situations of the patient is combined with the screw body 120 and the probability of success of orthodontic treatment may be improved and patient's inconvenience may be significantly reduced. Also, since the screw body 120 does not need to be removed from the periodontal tissues and to be replaced with other screw so as to replace the head 110, jawbone or periodontal tissues of the patient may not be injured more than necessary.

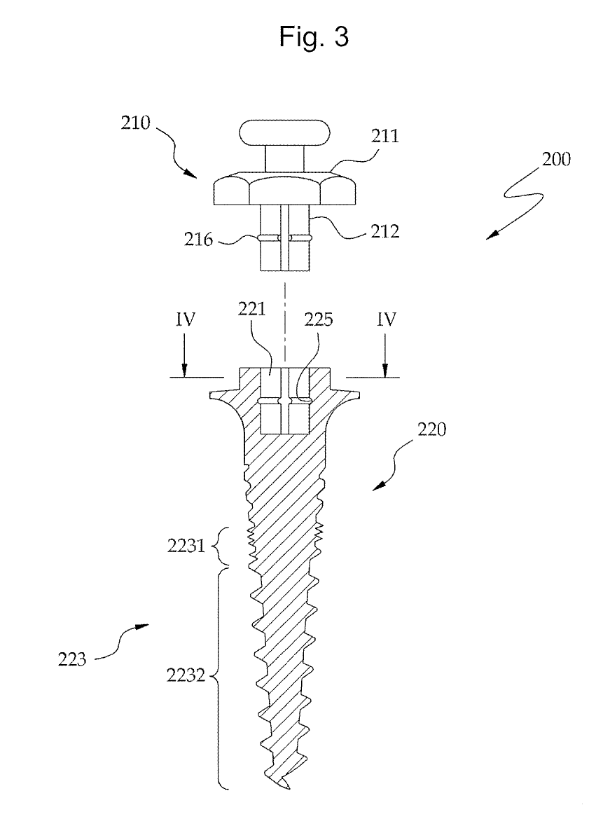

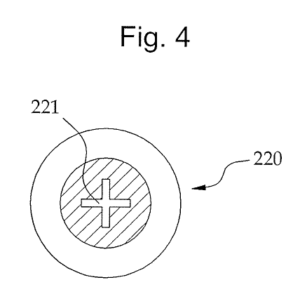

Next, an orthodontic implant screw assembly according to another embodiment of the present invention will be described. FIG. 3 is a front view of an orthodontic implant screw assembly 200 according to another embodiment of the present invention, and FIG. 4 is a cross-sectional view of the orthodontic implant screw assembly 200 illustrated in FIG. 3, taken along a line IV-IV.

The orthodontic implant screw assembly 200 according to the present embodiment includes a screw body 220 and a head 210, like in FIG. 1. The structure of the orthodontic implant screw assembly 200 of FIG. 2 is the same as that of the orthodontic implant screw assembly 100 of FIG. 1 in that the screw body 220 includes a male screw portion 223 and a combination hole 221 and the head 210 includes an insertion 212 and a protrusion 211. Also, the male screw portion 223 of the screw body 220 includes a single thread screw 2232 and a double thread screw 2231. However, the structure of the orthodontic implant screw assembly 200 of FIG. 2 is slightly different from that of the orthodontic implant screw assembly 100 of FIG. 1 in the structure of combination portions 225 and 216 due to the structure of the combination hole 221 and the insertion 212.

The combination hole 221 of the screw body 220 has a crossed cross-section and extends in the lengthwise direction, as illustrated in FIG. 4, and a female screw is not formed. The insertion 212 of the head 210 also has a crossed cross-section and is slid in the combination hole 221 of the screw body 220 and is inserted therein.

The combination portions 225 and 216 include an elastic portion 216 that is disposed on one of the head 210 and the screw body 220 and is elastically deformed when the insertion 212 is inserted in the combination hole 221, and a catch portion 225 that is disposed on the other one of the head 210 and the screw body 220, is caught on the elastic portion 216 and combines the head 210 and the screw body 220 with each other. In FIG. 3, the protrusion 216 formed of rubber is formed as the elastic portion 216 at an outside of the insertion 212, and the position determination groove 225 is formed as the catch portion 225 in a position of the combination hole 221 corresponding to the protrusion 216, wherein the shape of the position determination groove 225 is adapted to suit the shape of the protrusion 216.

When the insertion 212 of the head 210 is pushed in the combination hole 221 of the screw body 220 by applying force to the head 210, the protrusion 216 of the insertion 212 is elastically deformed, is slid in the combination hole 221, is elastically restored in the position determination groove 225 of the combination hole 221 and is caught thereon.

Generally, when orthodontic treatment of the mouth structure of the patient is performed using the orthodontic implant screw assembly 200 of FIG. 3, force is mainly applied to the orthodontic implant screw assembly 200 in a direction perpendicular to a lengthwise direction of the orthodontic implant screw assembly 200, and force applied to the orthodontic implant screw assembly 200 in a direction parallel to the lengthwise direction of the orthodontic implant screw assembly 200 is relatively small. Thus, even when the combination portions 216 and 225 have the structure described above, a probability that the insertion 212 of the head 210 may be detached from the combination hole 221 of the screw body 220 during orthodontic treatment, is low. On the other hand, when the head 210 is pulled out from the screw body 220 by applying force to the head 210, due to the elastic portion 216, the insertion 212 may be easily detached from the combination hole 221, and if necessary, the head 210 having other structure and shape may be combined with the screw body 220 so that orthodontic treatment may be more easily performed.

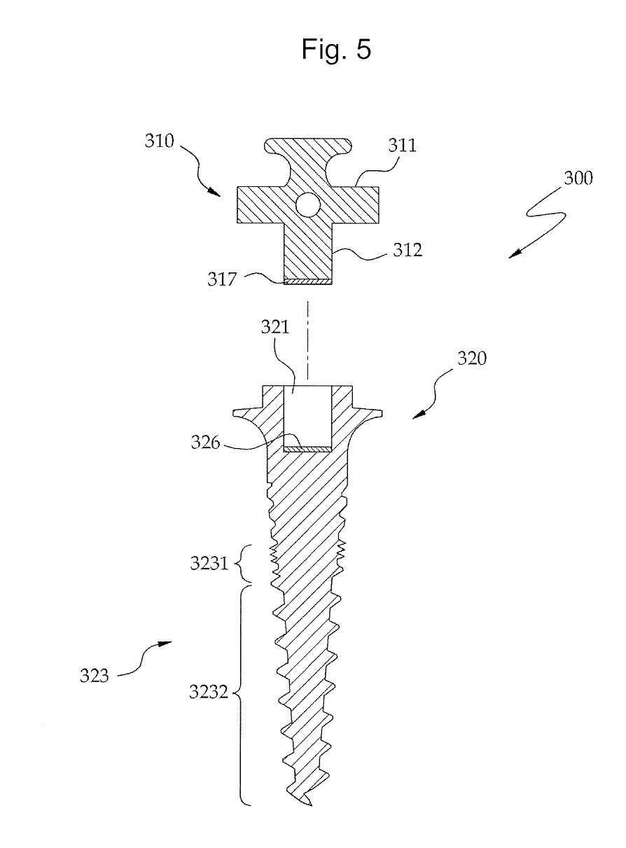

Next, an orthodontic implant screw assembly according to another embodiment of the present invention will be described with reference to FIG. 5. FIG. 5 is a front view of an orthodontic implant screw assembly 300 according to another embodiment of the present invention.

Like in FIG. 3, the orthodontic implant screw assembly 300 according to the present embodiment includes a screw body 320 and a head 310. The screw body 320 is inserted and fixed in periodontal tissues by using a male screw portion 323, and the head 310 includes an insertion 312 and a protrusion 311 and is combined with the screw body 320. The male screw portion 323 of the screw body 320 includes a single thread screw 3232 and a double thread screw 3231. The orthodontic implant screw assembly 300 of FIG. 3 is different from the orthodontic implant screw assembly 100 or 200 of FIG. 1 or 2 in the structure of combination portions.

The insertion 312 of the screw body 320 has no male screw formed outside the insertion 312 and extends simply in the lengthwise direction. A cross-section of the insertion 312 may be circular or non-circular if necessary.

The combination hole 321 of the screw body 320 is formed to have a shape corresponding to the cross-section of the insertion 312 and extends in the lengthwise direction.

The head 310 is combined with the screw body 320 in such a way that the insertion 312 is slid in the combination hole 321 along an extension direction of the combination hole 321 and is inserted therein.

In this case, permanent magnets 317 and 326 are disposed on the head 310 and the screw body 320. In the current embodiment, the permanent magnets 317 and 326 are installed at an end of the insertion 312 and the lowermost side of the combination hole 321. Thus, when the insertion 312 is pushed in the combination hole 321, an attractive force is applied between the permanent magnets 317 and 326 so that the head 310 and the screw body 320 may be combined with each other. By using the structure, the head 310 may be easily combined with the screw body 320 without the driver, and when the head 310 needs to be replaced with other one, the head 310 may be pulled out and may be detached from the screw body 320. As described above, since a large force is not applied to the head 310 in its lengthwise direction during orthodontic treatment, by using only a combination force of the permanent magnets 317 and 326, the head 310 may be easily combined with the screw body 320 and may be easily detached therefrom when the head 310 is replaced with other one.

When the cross-section of the insertion 312 is non-circular, the head 310 is not rotated relative to the screw body 320. Thus, when the head 310 and the screw body 320 are combined with each other, the screw body 320 may be inserted in periodontal tissues by rotating the head 310 by using a driver or wrench. Also, when orthodontic treatment of the mouth structure is performed by applying force to the protrusion 311 of the head 310 by using wires, orthodontic treatment may be performed by applying a torque to the head 310 as well as by applying a lateral force thereto. Also, in the orthodontic implant screw assembly 300 of FIG. 5, screw-combination is not used when the head 310 and the screw body 320 are combined with each other. Thus, a problem in which screw-combination of the head 310 and the screw body 320 may be released during orthodontic treatment, does not occur.

Although exemplary embodiments of the present invention have been described as above, the scope of the present invention is not limited to the structure and shape described above.

For example, although a protrusion having a different structure has been illustrated in FIGS. 1, 3, and 5, the structure of the protrusion may be changed in various ways if necessary. In other words, a driver slot may be formed, and a hole or groove in which wires are fixed, may be formed, and the protrusion may be bolt-shaped so as to rotate a head by using a wrench. Also, the height of the protrusion may be adjusted in various ways, and when the protrusion is not temporarily used in orthodontic treatment, a protrusion having a small height may be used.

Furthermore, although the male screw portion includes a single thread screw and a double thread screw, the male screw portion may not include a double thread screw but may be formed as a single thread screw. The shape of a thread of the male screw portion may be diverse, such as triangular, rectangular or the like.

Furthermore, although the adhesion grooves 131 having the uneven surfaces 115 and 122 are illustrated in FIG. 1 but are not included in FIGS. 3 and 5, FIGS. 3 and 5 may include the uneven surfaces 115 and 122 and the adhesion grooves 131 if necessary.

In an orthodontic implant screw assembly according to the present invention, when the orthodontic implant screw assembly is not temporarily used according to operations of orthodontic treatment of a mouth structure, a head having a small height and a small size can be replaced with other one so that patient's inconvenience can be reduced.

Furthermore, in the orthodontic implant screw assembly according to the present invention, when the orthodontic implant screw assembly including a head having a different shape according to the operations of orthodontic treatment of the mouth structure needs to be used, the orthodontic implant screw assembly is not replaced with other one but only an upper head of the orthodontic implant screw assembly is replaceable so that efficiency of orthodontic treatment can be improved and patient's inconvenience can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An orthodontic implant screw assembly comprising:
a screw body comprising a male screw portion inserted and fixed in periodontal tissues or jawbone and a combination hole extending from an upper side of the male screw portion in a lengthwise direction;
a head comprising an insertion inserted in the combination hole of the screw body and a protrusion formed at an upper side of the insertion and protruding from an upper side of the screw body; and
combination portions combining the head with the screw body when the insertion of the head is inserted in the combination hole of the screw body,
wherein sandblasted uneven surfaces are formed on surfaces in which the screw body and the protrusion of the head face each other, and
adhesion grooves are formed between the uneven surface of the screw body and the uneven surface of the head in such a way that the screw body and the head adhere each other by using a dental adhesive.

2. The orthodontic implant screw assembly of claim 1, wherein the upper side of the male screw portion of the screw body is formed as a double thread screw, and a lower side of the male screw portion of the screw body is formed as a single thread screw, and a pitch of the single thread screw is twice of a pitch of the double thread screw.

3. The orthodontic implant screw assembly of claim 1, wherein the combination portions comprise a male screw formed outside the insertion of the head and a female screw formed in the combination hole of the screw body, and the insertion of the head is screw-combined with the combination hole of the screw body.

4. The orthodontic implant screw assembly of claim 2, wherein the combination portions comprise a male screw formed outside the insertion of the head and a female screw formed in the combination hole of the screw body, and the insertion of the head is screw-combined with the combination hole of the screw body.

5. The orthodontic implant screw assembly of claim 1, wherein the insertion of the head is slid in the combination hole of the screw body along an extension direction of the combination hole and is inserted in the combination hole, and the combination portions comprise an elastic portion that is disposed on one of the head and the screw body and is elastically deformed when the insertion is inserted in the combination hole, and a catch portion that is disposed on the other one of the head and the screw body, is caught on the elastic portion and combines the head and the screw body with each other.

6. The orthodontic implant screw assembly of claim 5, wherein the elastic portion is a protrusion formed at an outside of the insertion, and the catch portion is a position determination groove in a position of the combination hole of the screw body corresponding to the protrusion, wherein a shape of the position determination groove is adapted to suit a shape of the protrusion.

7. The orthodontic implant screw assembly of claim 5, wherein a cross-section of the insertion of the head is non-circular, and a cross-section of the combination hole of the screw body corresponds to the cross-section of the insertion.

8. The orthodontic implant screw assembly of claim 1, wherein the insertion of the head is slid in the combination hole of the screw body along an extension direction of the combination hole and is inserted in the combination hole, and the combination portions comprise permanent magnets respectively disposed on the head and the screw body.
